(19) United States
(12) Patent Application Publication
(10) Pub. No.: US 2002/0174290 A1
(43) Pub. Date: Nov. 21, 2002

(54) Memory accelerator, acceleration method and associated interface card and motherboard

(76) Inventors: Kun Ho Wu, Feng-Shan (TW); Hai Feng Chuang, Tainan (TW)

Correspondence Address: J.C. Patents, Inc., Suite 114, 1340 Reynolds Ave., Irvine, CA, 92614, US

(21) Appl. No.: 09/932,625

(22) Filed: Aug. 17, 2001

Related U.S. Application Data
(60) Provisional application No. 60/291,485, filed on May 15, 2001.

(51) Int. Cl. G06F 12/00

(52) U.S. Cl. 711/104; 711/167

(57) ABSTRACT

A memory accelerator and associated interface card and motherboard. The memory accelerator has a memory bus acceleration system device and a memory bus accelerator. The memory bus acceleration system device processes signals between a chipset and the memory bus accelerator. The memory bus accelerator receives signals from the memory bus acceleration system device to conduct data transmission and reception and perform data conversion with corresponding memory. The method of increasing memory access speed includes providing an access command within an access cycle so that the memory bus accelerators can sequentially access data within the access cycle according to the access command and perform a data access operation with corresponding memory.

### CROSS-REFERENCE TO RELATED APPLICATION

This application claims the priority benefit of Taiwan application serial no. 60/291,485, filed May 15, 2001.

### BACKGROUND OF THE INVENTION

1. Field of Invention

The present invention relates to a memory device, an operating method and associated interface card and motherboard. More particularly, the present invention relates to a memory accelerator, an acceleration method and associated interface card and motherboard.

2. Description of Related Art

Due to the rapid advance in computer manufacturing and packaging technologies, the processing speed of a central processing unit (CPU) follows Moore's law of growth, while the size of the chip is also reduced. Despite such accelerated growth, memory speed can hardly reach the bandwidth level required by a microprocessor. Hence, there is still room for an increase in operating efficiency of the entire system. In other words, even if more memory is added to the system so that memory storage capacity is increased, overall effect on the bandwidth of the entire system is minimal.

### SUMMARY OF THE INVENTION

Accordingly, one object of the present invention is to provide a memory accelerator, an acceleration method and associated interface card and motherboard capable of increasing data bandwidth of the memory such that each additional memory module can increase operating speed. Hence, memory storage capacity as well as operating speed of a system is increased for each additional memory module.

To achieve these and other advantages and in accordance with the purpose of the invention, as embodied and broadly described herein, the invention provides a memory accelerator. The memory accelerator has a memory bus acceleration system device and a memory bus accelerator. The memory bus accelerator is coupled to the memory bus acceleration system device.

When the memory bus acceleration system device receives signals from a chipset, the chipset signal is transformed before re-submitting the signal. After receiving a signal from the bus acceleration system device, the memory bus accelerator controls signal conversion and data access operations between the memory bus acceleration system device and corresponding memory according to the signal sent from the bus acceleration system device.

After receiving a data access command from the chipset, the memory bus acceleration system device outputs an access command converted according to the data access command to the memory bus accelerator so that the memory bus accelerator sequentially accesses the data on the memory bus before accessing data in the corresponding memory location.

The memory bus acceleration system device of this invention also includes a data function device and a command state device. The command state device is coupled to the data function device. After receiving the data access command from the chipset and the state from the memory bus accelerator, the command state device controls the data function device and the memory bus accelerator according to the data access command and the memory bus accelerator state. Henceforth, the data function device processes and controls data transmission between the chipset and the memory bus accelerator.

The memory bus accelerator of this invention also provides data transmission and control between a memory bus acceleration system device and memory through an interface. The memory interface includes a memory interface and control memory accelerator. The control memory accelerator is coupled to the memory interface. After transmitting a memory bus accelerator state to the memory bus acceleration system device, the control memory accelerator receives a memory bus acceleration system device command. The memory interface is controlled according to the memory bus acceleration system device command. Henceforth, the memory interface processes and controls data transmission between the memory bus acceleration system device and memory.

This invention also provides a method for accelerating memory performance that utilizes a memory bus accelerator to access data in memory. The method includes the steps of providing an access command during an access cycle, ordering the memory bus accelerator to access data sequentially during the access cycle according to the access command and accessing data in a corresponding memory location.

In brief, this invention utilizes the memory bus acceleration system device and the memory bus accelerator to control the transactions between chipset and memory. Within an access cycle, a plurality of memory bus accelerators sequentially accesses data in memory so that as more SDRAM or DDR SDRAM is added to increase memory capacity, operating speed of the memory is also increased. Moreover, the additional memory units will not slow down the operating speed of the chipset.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram of a memory accelerator according to one preferred embodiment of this invention;

FIG. 2 is a block diagram showing a portion of the memory accelerator according to one preferred embodiment of this invention;

FIG. 3 is a block diagram of a memory bus acceleration system device according to one preferred embodiment of this invention;

FIG. 4 is block diagram of an SDRAM bus accelerator according to one preferred embodiment of this invention;

FIG. 5 is a block diagram of a DDR SDRAM bus accelerator according to one preferred embodiment of this invention;

FIG. 6 is a block diagram of a memory accelerator according to one preferred embodiment of this invention;

FIG. 7 is a block diagram of another memory accelerator according to one preferred embodiment of this invention;

FIG. 8 is a flow diagram showing a method of increasing memory performance according to one preferred embodiment of this invention;

FIG. 9A is a timing diagram for a group of memory bus accelerators in a write operation according to one preferred embodiment of this invention;

FIG. 9B is a timing diagram for a group of memory bus accelerators in a read operation according to one preferred embodiment of this invention;

FIG. 10A is a timing diagram for two groups of memory bus accelerators in a write operation according to one preferred embodiment of this invention;

FIG. 10B is a timing diagram for two groups of memory bus accelerators in a read operation according to one preferred embodiment of this invention;

FIG. 11A is a timing diagram for three groups of memory bus accelerators in a write operation according to one preferred embodiment of this invention;

FIG. 11B is a timing diagram for three groups of memory bus accelerators in a read operation according to one preferred embodiment of this invention;

FIG. 12A is a timing diagram for four groups of memory bus accelerators in a write operation according to one preferred embodiment of this invention;

FIG. 12B is a timing diagram for four groups of memory bus accelerators in a read operation according to one preferred embodiment of this invention;

FIG. 13A is a timing diagram for a group of memory bus accelerators in a write operation according to one preferred embodiment of this invention;

FIG. 13B is a timing diagram for a group of memory bus accelerators in a read operation according to one preferred embodiment of this invention;

FIG. 14A is a timing diagram for two groups of memory bus accelerators in a write operation according to one preferred embodiment of this invention;

FIG. 14B is a timing diagram for two groups of memory bus accelerators in a read operation according to one preferred embodiment of this invention;

FIG. 15A is a timing diagram for two groups of memory bus accelerators in a write operation according to one preferred embodiment of this invention;

FIG. 15B is a timing diagram for two groups of memory bus accelerators in a read operation according to one preferred embodiment of this invention;

FIG. 16A is a timing diagram for three groups of memory bus accelerators in a write operation according to one preferred embodiment of this invention;

FIG. 16B is a timing diagram for three groups of memory bus accelerators in a read operation according to one preferred embodiment of this invention;

FIG. 17 is a block diagram showing a motherboard using a first type of memory accelerator according to one preferred embodiment of this invention;

FIG. 18 is a block diagram showing a motherboard using a second type of memory accelerator according to one preferred embodiment of this invention;

FIG. 19 is a block diagram showing a motherboard using a third type of memory accelerator according to one preferred embodiment of this invention;

FIG. 20 is a block diagram showing a motherboard using a fourth type of memory accelerator according to one preferred embodiment of this invention;

FIG. 21 is a block diagram showing a motherboard using a fifth type of memory accelerator according to one preferred embodiment of this invention;

FIG. 22 is a block diagram showing a motherboard using a sixth type of memory accelerator according to one preferred embodiment of this invention;

FIG. 23 is a block diagram showing a portable computer motherboard using a first type of memory accelerator according to one preferred embodiment of this invention;

FIG. 24 is a block diagram showing a portable computer motherboard using a second type of memory accelerator according to one preferred embodiment of this invention;

FIG. 25 is a block diagram showing a portable computer motherboard using a third type of memory accelerator according to one preferred embodiment of this invention;

FIG. 26 is a block diagram showing a portable computer motherboard using a fourth type of memory accelerator according to one preferred embodiment of this invention;

FIG. 27 is a block diagram showing a portable computer motherboard using a fifth type of memory accelerator according to one preferred embodiment of this invention;

FIG. 28 is a block diagram showing a portable computer motherboard using a sixth type of memory accelerator according to one preferred embodiment of this invention;

FIG. 29 is a block diagram showing an interface card using a first type of memory accelerator according to one preferred embodiment of this invention;

FIG. 30 is a block diagram showing an interface card using a second type of memory accelerator according to one preferred embodiment of this invention;

FIG. 31 is a block diagram showing an interface card using a third type of memory accelerator according to one preferred embodiment of this invention;

FIG. 32 is a block diagram showing an interface card using a fourth type of memory accelerator according to one preferred embodiment of this invention;

FIG. 33 is a block diagram showing an interface card using a fifth type of memory accelerator according to one preferred embodiment of this invention; and

FIG. 34 is a block diagram showing an interface card using a sixth type of memory accelerator according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

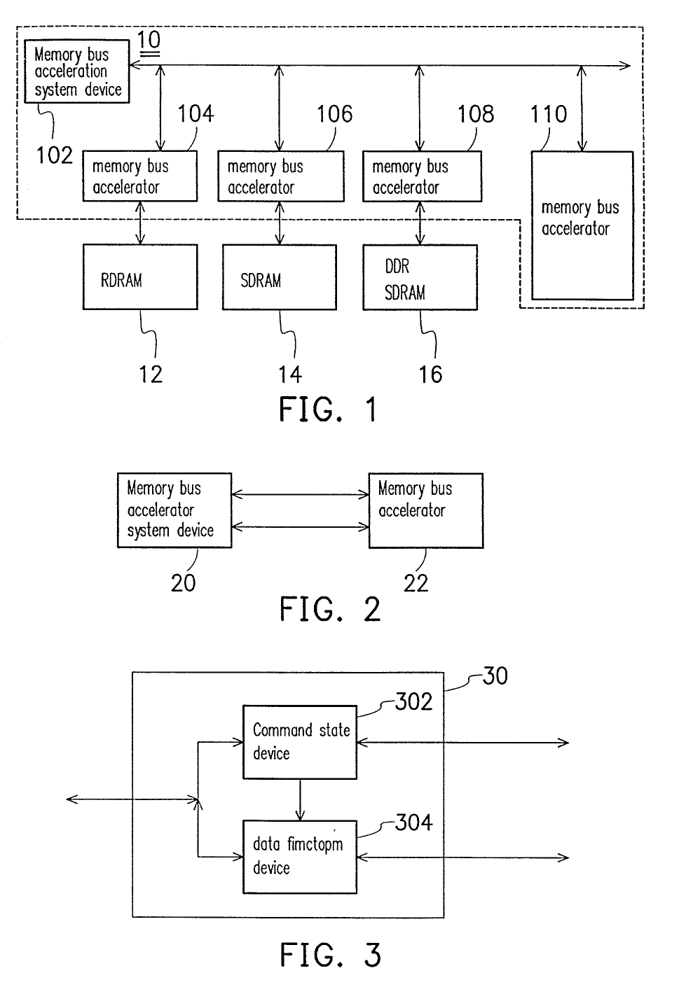

FIG. 1 is a block diagram of a memory accelerator according to one preferred embodiment of this invention. As shown in FIG. 1, the memory accelerator of this invention can be divided into two major sections, a memory bus acceleration system device 10, including memory bus accelerators 104, 106, 108, and a memory accelerator 110. The memory bus accelerators (104, 106 and 108) can be applied to memory having different operating speeds such as RDRAM 12, SDRAM 14 and DDR SDRAM 16 respectively.

FIG. 2 is a block diagram showing a portion of the memory accelerator according to one preferred embodiment of this invention. First, the memory bus acceleration system device 20 receives a chipset signal. A signal conversion of the chipset signal is conducted. Thereafter, the memory bus accelerator 22 picks up the converted chipset signal from the bus acceleration system device 20. According to the converted chipset signal from the memory bus acceleration system device 20, a decision to transmit or receive data is determined. Finally, data access with the corresponding memory is conducted. The memory bus accelerator 22 is coupled to the memory bus acceleration system device 20. For example, when the memory bus acceleration system device 20 receives a data access command from the chipset, the memory bus acceleration system device 20 converts the data access command into an access command and outputs the access command to the memory bus accelerator 22. Hence, the memory bus accelerator 22 is able to access data on the memory bus sequentially. Finally, data access between the memory bus accelerator 22 and corresponding memory is conducted. Note that aside from application to a chipset, the aforementioned invention can also be applied to an interface chip.

FIG. 3 is a block diagram of a memory bus acceleration system device according to one preferred embodiment of this invention. As shown in FIG. 3, the memory bus acceleration system device 30 can be divided into two major sections, a command state device 302 and a data function device 304. As the command state device 302 receives commands from the chip set and state data from the memory bus accelerator 30, the data function device 304 and the memory bus accelerator 30 are controlled according to the chipset command and memory bus accelerator state. Thereafter, the data function device 304 provides data transmission and control for any operations between the chipset and the memory bus accelerator. For example, when the command state device 302 receives a write data command from the chipset and state data from the memory bus accelerator 30, the write command is output to the memory bus accelerator 30 to control the data function device 304. The data function device 304 initiates a data write operation to write data into memory together with the chipset and the memory bus accelerator 30.

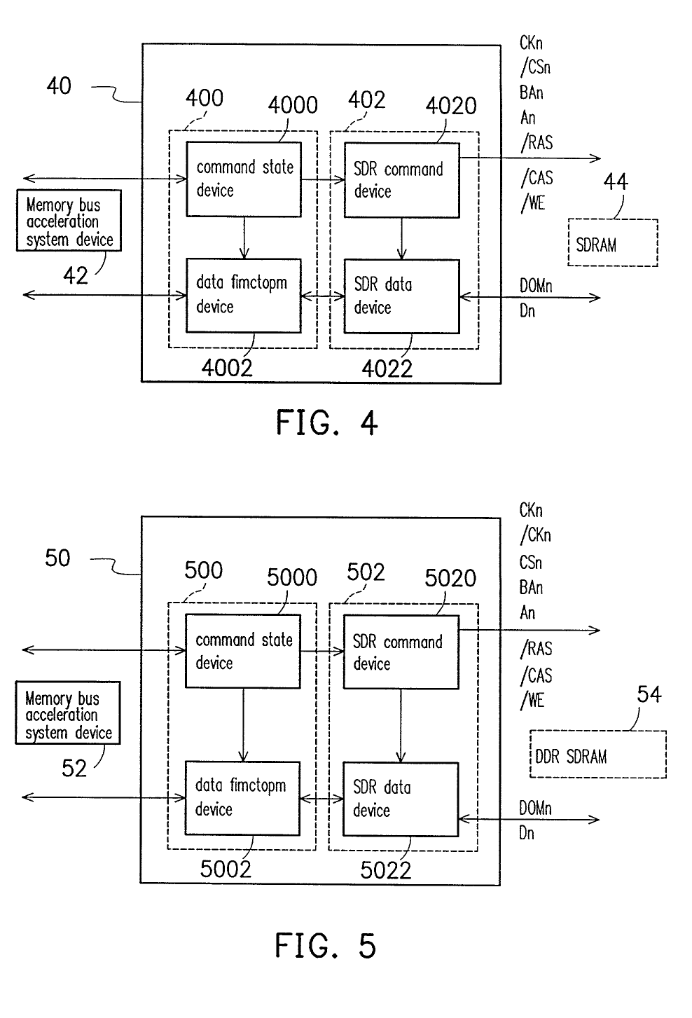

FIG. 4 is block diagram of an SDRAM bus accelerator according to one preferred embodiment of this invention. To illustrate the memory bus accelerator better, the memory is SDRAM. In this embodiment, the memory accelerator 40 can be divided into two major sections, a control memory accelerator 400 and an SDRAM interface 402. First, the control memory accelerator 400 transfers current state of the memory bus accelerator 400 to the memory bus acceleration system device 42 and receives commands from the memory bus acceleration system device 42. According to the commands sent from the memory bus acceleration system device 42, the SDRAM interface 402 is controlled. Henceforth, the SDRAM interface 402 controls and processes any data transmission between the memory bus accelerator 400 and SDRAM 44.

The control memory accelerator 400 can be further divided into two sections, a command state device 4000 and a data function device 4002. The command state device 4000 transfers state data of the memory bus accelerator 40 to the memory bus acceleration system device 42 and receives commands from the memory bus acceleration system device 42. According to the commands from the memory bus acceleration system device 42, the SDRAM interface 402 and the data function device 4002 are controlled. Henceforth, the data function device 4002 controls and processes any data transmission between the memory bus acceleration system device 42 and the SDRAM interface 402.

The SDRAM interface 402 can be further divided into two sections, an SDR command device 4020 and an SDR data device 4022. After receiving commands from the memory bus accelerator 400, the SDR command device 4020 outputs memory control signal to the SDRAM 44 according to the commands from the memory bus accelerator 400. After receiving the memory control signal, the SDRAM 44 provides data transmission and control function together with the SDR data device 4022. Thereafter, the SDR data device 4022 and the memory bus accelerator 400 together also provide data transmission and control functions.

FIG. 5 is a block diagram of a DDR SDRAM bus accelerator according to one preferred embodiment of this invention. To illustrate the memory bus accelerator better, the memory is DDR SDRAM. In this embodiment, the memory accelerator 50 can be divided into two major sections, a control memory accelerator 500 and a DDR SDRAM interface 502. First, the control memory accelerator 500 transfers current state of the memory bus accelerator 500 to the memory bus acceleration system device 52. According to the commands sent from the memory bus acceleration system device 52, the DDR SDRAM interface 502 is controlled. Henceforth, the DDR SDRAM interface 502 controls and processes any data transmission between the memory bus accelerator 500 and DDR SDRAM 54.

The control memory accelerator 500 can be further divided into two sections, a command state device 5000 and a data function device 5002. The command state device 5000 transfers state data of the memory bus accelerator 50 to the memory bus acceleration system device 52 and receives commands from the memory bus acceleration system device 52. According to the commands from the memory bus acceleration system device 52, the DDR SDRAM interface 502 and the data function device 5002 are controlled. Henceforth, the data function device 5002 controls and processes any data transmission between the memory bus acceleration system device 52 and the DDR SDRAM interface 502.

The DDR SDRAM interface 502 can be further divided into two sections, a DDR command device 5020 and a DDR data device 5022. After receiving commands from the memory bus accelerator 500, the DDR command device 5020 outputs memory control signal to the DDR SDRAM 54 according to the commands from the memory bus accelerator 500. After receiving the memory control signal, the DDR SDRAM 54 provides data transmission and control function together with the DDR data device 5022. Thereafter, the DDR data device 5022 and the memory bus accelerator 500 together also provide data transmission and control functions.

In this embodiment, SDRAM and DDR SDRAM serve as example of memory. In fact, anyone familiar with such techniques may know that the invention can be applied to many types of memories. For example, a memory interface that operates SDRAM is an SDRAM interface, a memory command device that operates SDRAM is an SDR command device, and a memory data device that operates SDRAM is an SDR data device.

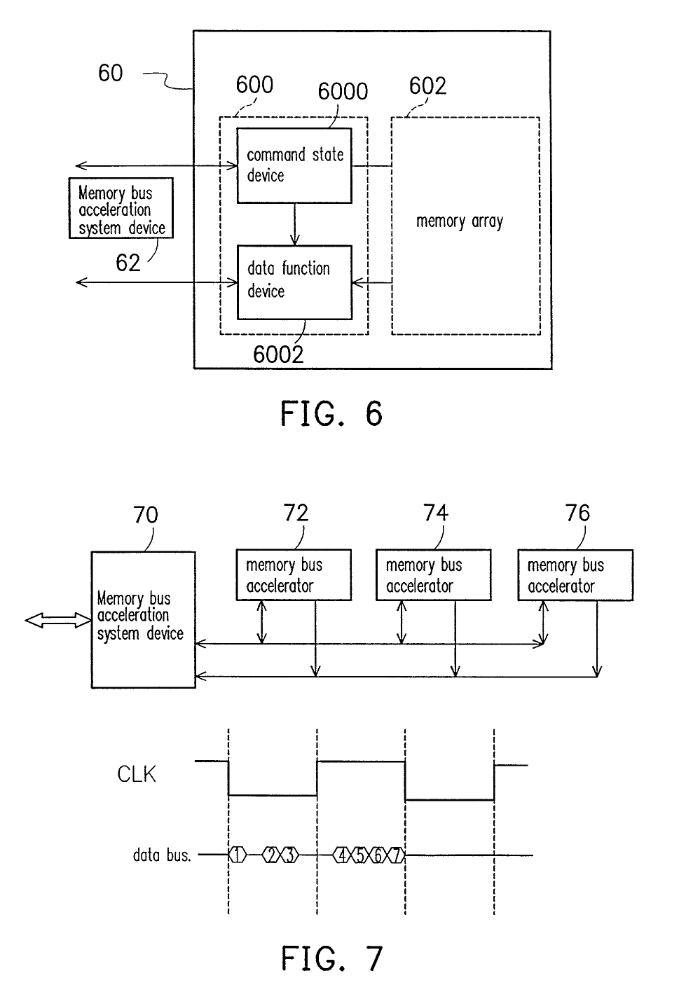

FIG. 6 is a block diagram of a memory accelerator according to one preferred embodiment of this invention. First, a control memory accelerator 600 inside the memory accelerator 60 transmits current state of the control memory accelerator 600 to a memory bus acceleration system device 62 and receives commands from the memory bus acceleration system device 62. According to the commands from the memory bus acceleration system device 62, a memory array 602 is controlled.

The control memory accelerator 600 can be further divided into two sections, a command state device 6000 and a data function device 6002. After transmitting the state of the control memory accelerator 600 to the memory bus acceleration system device 62, the command state device 6000 receives commands from the memory bus acceleration system device 62. The commands from the memory bus acceleration system device 62 serves to control the memory array 602 and the data function device 6002 so that the data function device 6002 and the memory bus acceleration system device 62 together control data transmission.

FIG. 7 is a block diagram of another memory accelerator according to one preferred embodiment of this invention. The memory accelerator in FIG. 7 has ten channels. When a memory bus accelerator 72 having one fold increase in data speed is also incorporated, data transmission speed of the entire structure increases one fold. If a memory accelerator 74 having a two-fold increase in data speed is added, data transmission speed of the entire structure increases three folds. If a memory acceleration 76 having a four-fold increase in data speed is further added, data transmission speed of the entire structure increases seven folds. Hence, data transmission speed of the memory accelerator may increase as technology or processing speed of the memory bus improves.

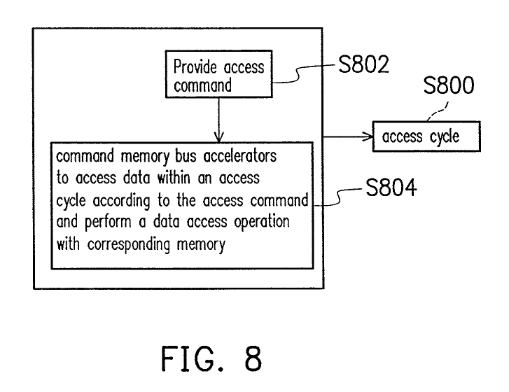

According to the operation of the aforementioned devices, a method for speeding up memory operation is created. FIG. 8 is a flow diagram showing a method of increasing memory performance according to one preferred embodiment of this invention. The method includes accessing data within a memory unit via a memory bus accelerator. The step of executing an entire access cycle S800 can be subdivided into two steps, S802 and S804. In step S802, access commands are provided. In step S804, the memory bus accelerator sequentially accesses data within the access cycle S800 according to access commands and performs data access operations with corresponding memory.

To explain how a memory accelerator is able to increase data accessing speed of a system, the timing diagrams of a four-channel memory accelerator are displayed and described in the following.

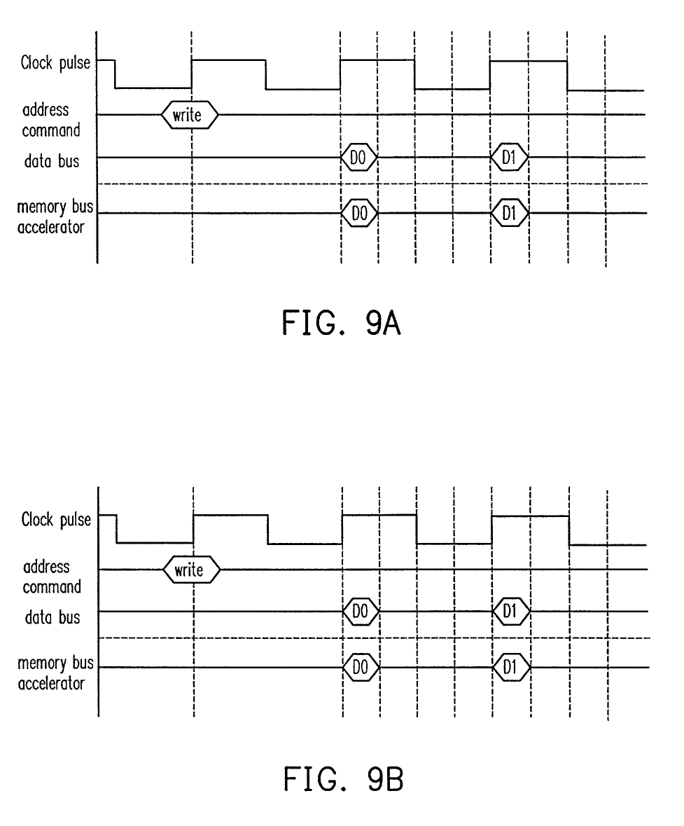

FIG. 9A is a timing diagram of a group of memory bus accelerators in a data write operation according to this invention. When the system transmits a write command to the memory accelerator, if the system happens to use just one group of memory bus and the memory is SDRAM, data D0 will appear on the data bus. After the data D0 is processed by a memory bus accelerator, the processed data D0 is written to the SDRAM.

FIG. 9B is a timing diagram of a group of memory bus accelerators in a data read operation according to this invention. When the system transmits a read command to the memory accelerator, if the system happens to use just one group of memory bus and the memory is SDRAM, the memory bus accelerator retrieves data D0 from the SDRAM and transfers the data D0 to the data bus.

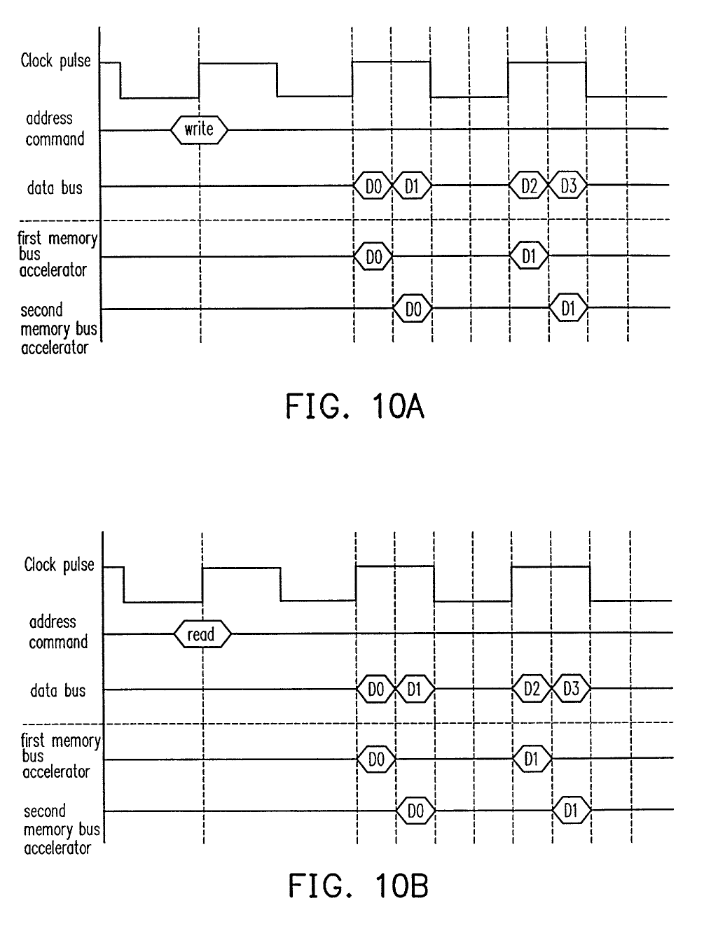

FIG. 10A is a timing diagram of two groups of memory bus accelerators in a data write operation according to this invention. When the system transmits a write command to the memory accelerator, if the system happens to use two groups of memory buses and the memory is SDRAM, data D0 and D1 will appear on the data buses. After the data D0 is processed by a first memory bus accelerator, the processed data D0 is written to the SDRAM. Similarly, after the data D1 is processed by a second memory bus accelerator, the processed data D1 is written to the SDRAM. For example, a chipset issues a data write command. When the memory bus acceleration system device receives the data write command, a write command is output to the first memory bus accelerator and the second memory bus accelerator. The command state device inside the first memory bus accelerator and the command state device inside the second memory bus accelerator receive the write command and re-submit a write command to the data function bus and the SDR command device respectively. The SDR command device issues a write command to corresponding SDRAM in preparation for the data write operation. Data D0 and D1 are written to the data bus via the chipset. Thereafter, the data function device of the first memory bus accelerator and the data function device of the second memory bus accelerator sequentially fetch data from the data buses and write the data to the SDRAM via the SDR data device.

FIG. 10B is a timing diagram of two groups of memory bus accelerators in a data read operation according to this invention. When the system transmits a read command to the memory accelerator, if the system happens to use two groups of memory buses and the memory is SDRAM, a first memory bus accelerator retrieves data D0 from the SDRAM while the second memory bus accelerator retrieves data D1 from the SDRAM. The data D0 and D1 are sequentially transmitted to the data bus. For example, a chipset issues a data read command. When the memory bus acceleration system device receives the data read command, a read command is output to the first memory bus accelerator and the second memory bus accelerator. The command state device inside the first memory bus accelerator and the command state device inside the second memory bus accelerator receive the read command and re-submit a read command to the data function bus and the SDR command device respectively. The SDR command device issues a read command to corresponding SDRAM while corresponding SDRAM issues data to the data function device via the SDR data device. Thereafter, the data function device sequentially transfers data D0 and D1 to the data bus.

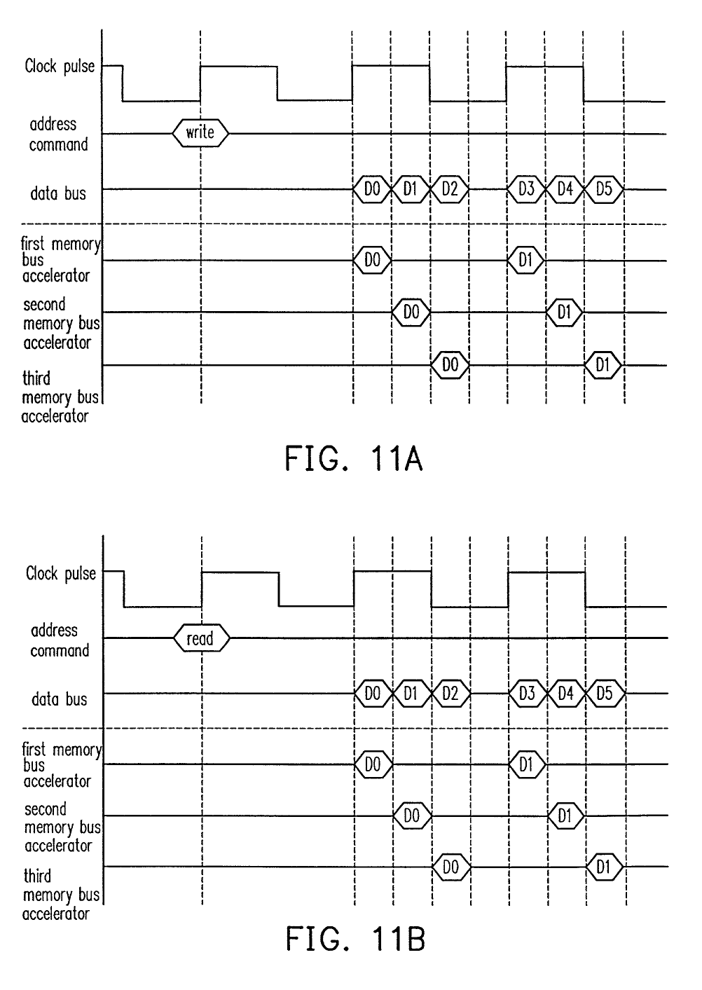

FIG. 11A is a timing diagram of three groups of memory bus accelerators in a data write operation according to this invention. When the system transmits a write command to the memory accelerator, if the system happens to use three groups of memory buses and the memory is SDRAM, data D0, D1 and D2 will appear on the data buses. After the data D0 is processed by a first memory bus accelerator, the processed data D0 is written to the SDRAM. After the data D1 is processed by a second memory bus accelerator, the processed data D1 is written to the SDRAM. Similarly, after the data D2 is processed by a third memory bus accelerator, the processed data D2 is written to the SDRAM.

FIG. 11B is a timing diagram of three groups of memory bus accelerators in a data read operation according to this invention. When the system transmits a read command to the memory accelerator, if the system happens to use three groups of memory buses and the memory is SDRAM, the first memory bus accelerator retrieves data D0 from the SDRAM, the second memory bus accelerator retrieves data D1 from the SDRAM and the third memory bus accelerator retrieves data D2 from the SDRAM. Thereafter, data D0, D1 and D2 are sequentially transmitted to the data bus.

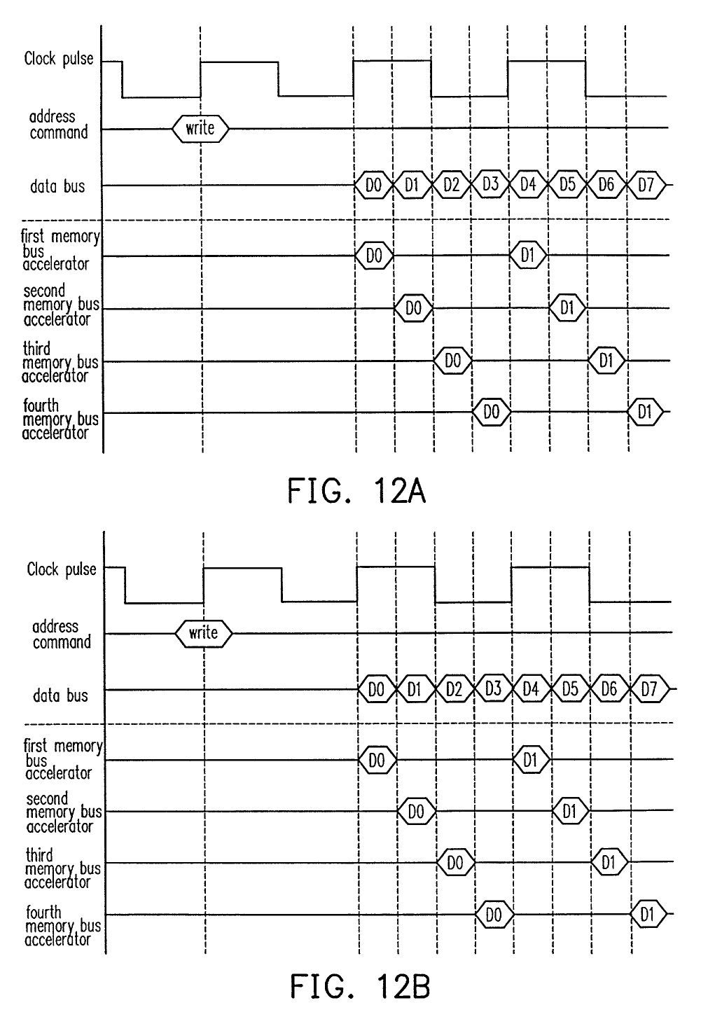

FIG. 12A is a timing diagram of four groups of memory bus accelerators in a data write operation according to this invention. When the system transmits a write command to the memory accelerator, if the system happens to use four groups of memory buses and the memory is SDRAM, data D0, D1, D2 and D3 will appear on the data buses. After the data D0 is processed by a first memory bus accelerator, the processed data D0 is written to the SDRAM. After the data D1 is processed by a second memory bus accelerator, the processed data D1 is written to the SDRAM. After the data D2 is processed by a third memory bus accelerator, the processed data D2 is written to the SDRAM. After the data D3 is processed by a third memory bus accelerator, the processed data D3 is written to the SDRAM.

FIG. 12B is a timing diagram of four groups of memory bus accelerators in a data read operation according to this invention. When the system transmits a read command to the memory accelerator, if the system happens to use four groups of memory buses and the memory is SDRAM, the first memory bus accelerator retrieves data D0 from the SDRAM, the second memory bus accelerator retrieves data D1 from the SDRAM, the third memory bus accelerator retrieves data D2 from the SDRAM and the fourth memory bus accelerator retrieves data D3 from the SDRAM. Thereafter, data D0, D1, D2 and D3 are sequentially transmitted to the data bus.

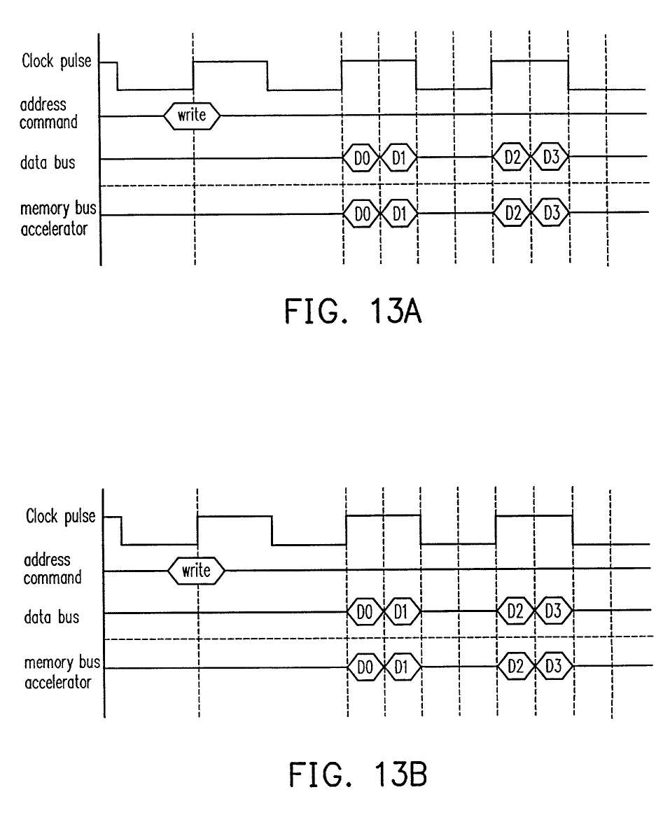

FIG. 13A is a timing diagram of a group of memory bus accelerators in a data write operation according to this invention. When the system transmits a write command to the memory accelerator, if the system happens to use just one group of memory bus and the memory is DDR SDRAM, data D0 and D1 will appear on the data bus. After the data D0 and D1 are processed by a memory bus accelerator, the processed data D0 and D1 are written to the DDR SDRAM.

FIG. 13B is a timing diagram of a group of memory bus accelerators in a data read operation according to this invention. When the system transmits a read command to the memory accelerator, if the system happens to use just one group of memory bus and the memory is DDR SDRAM, the memory bus accelerator retrieves data D0 and D1 from the DDR SDRAM and transfers the data D0 and D1 to the data bus.

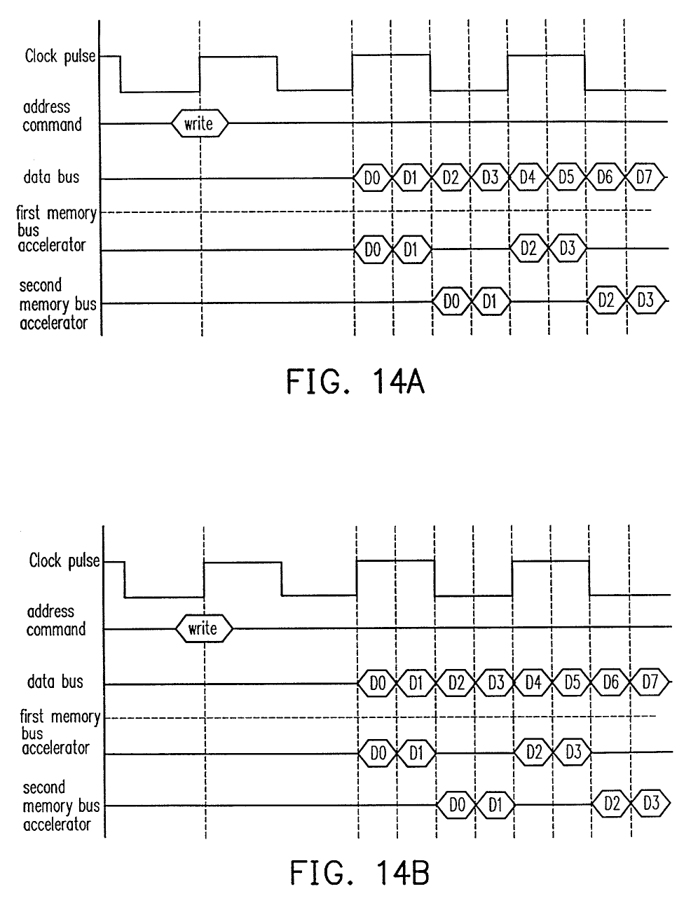

FIG. 14A is a timing diagram of two groups of memory bus accelerators in a data write operation according to this invention. When the system transmits a write command to the memory accelerator, if the system happens to use two groups of memory buses and the memory is DDR SDRAM, data D0, D1, D2 and D3 will appear on the data bus. After the data D0 and D1 are processed by a first memory bus accelerator, the processed data D0 and D1 are written to the DDR SDRAM. Similarly, after the data D2 and D3 are processed by a second memory bus accelerator, the processed data D2 and D3 are written to the DDR SDRAM.

FIG. 14B is a timing diagram of two groups of memory bus accelerators in a data read operation according to this invention. When the system transmits a read command to the memory accelerator, if the system happens to use two groups of memory buses and the memory is DDR SDRAM, the first memory bus accelerator retrieves data D0 and D1 from the DDR SDRAM and transfers the data D0 and D1 to the data bus. Similarly, the second memory bus accelerator retrieves data D2 and D3 from the DDR SDRAM and transfers the data D2 and D3 to the data bus.

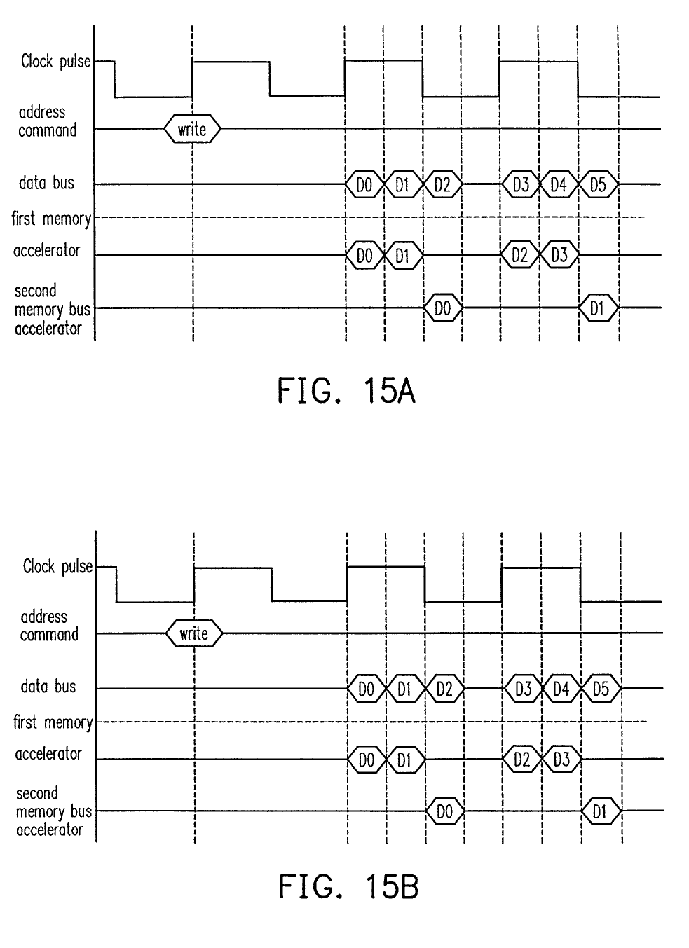

FIG. 15A is a timing diagram of two groups of memory bus accelerators in a data write operation according to this invention. When the system transmits a write command to the memory accelerator, if the system happens to use two groups of memory buses and the memory is SDRAM and DDR SDRAM data D0, D1, and D2 will appear on the data bus. After the data D0 and D1 are processed by a first memory bus accelerator, the processed data D0 and D1 are written to the DDR SDRAM. Similarly, after the data D2 is processed by a second memory bus accelerator, the processed data D2 is written to the SDRAM.

FIG. 15B is a timing diagram of two groups of memory bus accelerators in a data read operation according to this invention. When the system transmits a read command to the memory accelerator, if the system happens to use two groups of memory buses and the memory is SDRAM and DDR SDRAM, the first memory bus accelerator retrieves data D0 and D1 from the DDR SDRAM and transfers the data D0 and D1 to the data bus. Similarly, the second memory bus accelerator retrieves data D2 from the SDRAM and transfers the data D2 to the data bus.

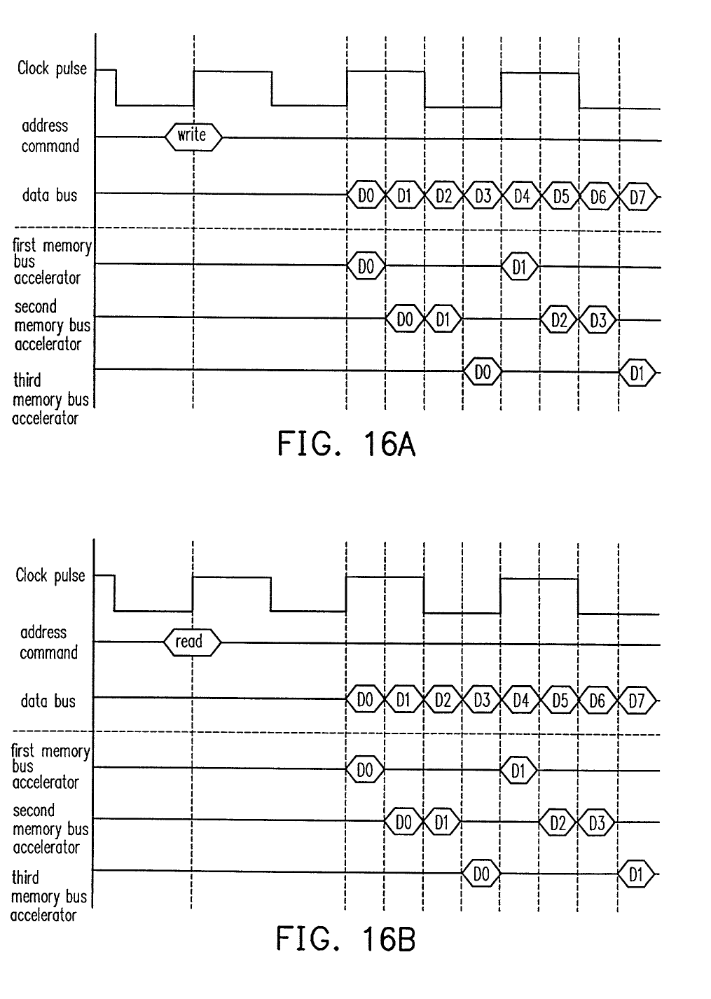

FIG. 16A is a timing diagram of three groups of memory bus accelerators in a data write operation according to this invention. When the system transmits a write command to the memory accelerator, if the system happens to use three groups of memory buses and the memory is two sets of SDRAM and one set of DDR SDRAM, data D0, D1, D2 and D3 will appear on the data bus. After the data D0 is processed by a first memory bus accelerator, the processed data D0 is written to the first set of SDRAM. After the data D1 and D2 are processed by a second memory bus accelerator, the processed data D1 and D2 are written to the DDR SDRAM. Similarly, after the data D3 is processed by a third memory bus accelerator, the processed data D3 is written to the second set of SDRAM.

FIG. 16B is a timing diagram of three groups of memory bus accelerators in a data read operation according to this invention. When the system transmits a read command to the memory accelerator, if the system happens to use three groups of memory buses and the memory is two sets of SDRAM and one set of DDR SDRAM, the first memory bus accelerator retrieves data D0 from the first set of SDRAM and transfers the data D0 to the data bus. The second memory bus accelerator retrieves data D1 and D2 from the DDR SDRAM and transfers the data D1 and D2 to the data bus. Similarly, the third memory bus accelerator retrieves data D3 from the second set of SDRAM and transfers the data D3 to the data bus.

As the number of memory bus accelerators and memory increases, memory data accessing speed within the system is increased. Moreover, the accessing speed is not restricted to a particular type of memory and the data writing sequence for the memory bus accelerators is not fixed. The cases shown in FIGS. 15A, B and FIGS. 16A, B are just one of the ordering state.

The invention can be applied to many types of systems including, for example, motherboard, portable computer motherboard and interface card. The following is a brief description of each system.

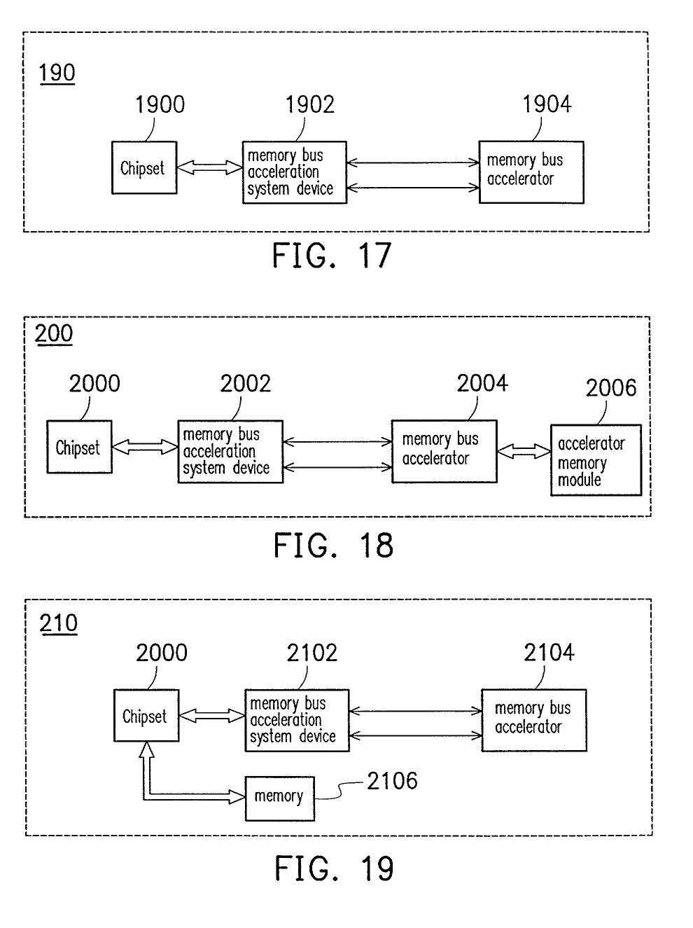

FIG. 17 is a block diagram showing a motherboard using a first type of memory accelerator according to one preferred embodiment of this invention. The motherboard 190 at least includes a chipset 1900, a memory bus acceleration system device 1902 and a memory bus accelerator 1904. The memory bus acceleration system device 1902 processes signals shuttling between the memory bus accelerator 1904 and the chipset 1900. The memory bus accelerator 1904 receives signals from the memory bus acceleration system device 1902 and conducts data transmission or reception according to signal data transmitted from the memory bus acceleration system device 1902. The memory bus accelerator 1904 also exchanges signals with memory.

FIG. 18 is a block diagram showing a motherboard using a second type of memory accelerator according to one preferred embodiment of this invention. The system is very similar to the one shown in FIG. 17. The memory bus accelerator can be further divided into a memory bus accelerator slot 2004 and an accelerator memory module 2006. The memory bus accelerator slot 2004 receives signals from the memory bus acceleration system device 2002 and conducts data transmission or reception accordingly. The memory bus accelerator slot 2004 also arbitrates the signals between the memory bus acceleration system device 2002 and the accelerator memory module 2006 and accesses data within the accelerator memory module 2006.

FIG. 19 is a block diagram showing a motherboard using a third type of memory accelerator according to one preferred embodiment of this invention. The system is very similar to the one shown in FIG. 17. However, unlike the system in FIG. 17 with memory attached to the memory bus accelerator, the memory 2106 and the chipset 2100 are coupled together so that memory data can be accessed directly via the chipset 2100.

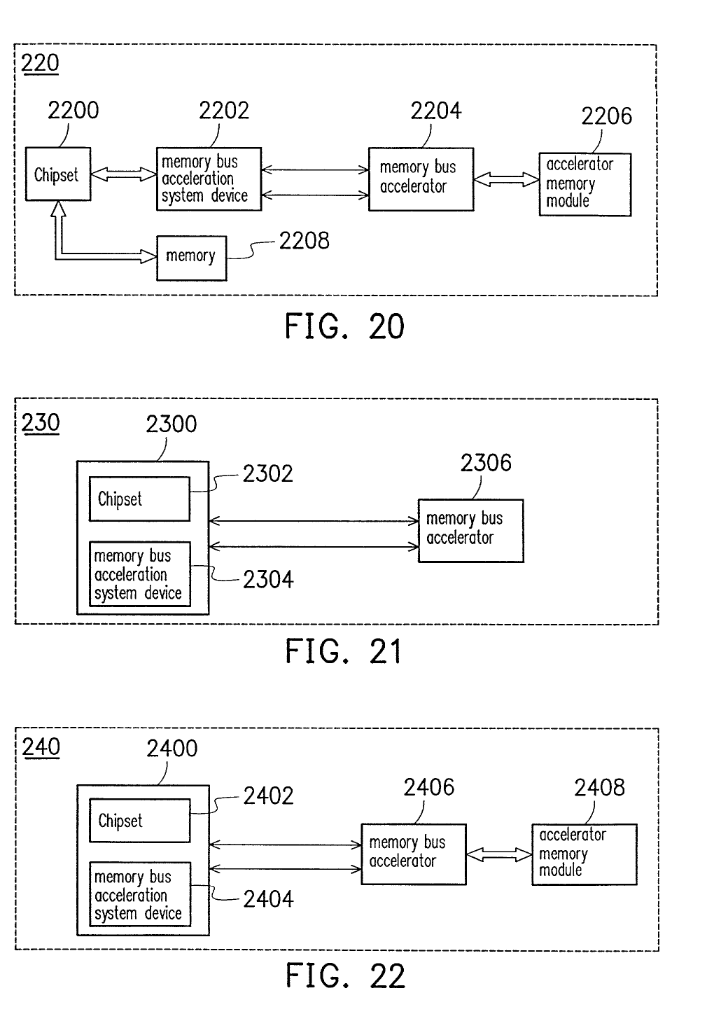

FIG. 20 is a block diagram showing a motherboard using a fourth type of memory accelerator according to one preferred embodiment of this invention. The system is very similar to the one shown in FIG. 18. However, unlike the system in FIG. 18 with memory attached to the memory bus accelerator slot, the memory 2206 and the chipset 2200 are coupled together so that memory data can be accessed directly via the chipset 2200.

FIG. 21 is a block diagram showing a motherboard using a fifth type of memory accelerator according to one preferred embodiment of this invention. The system is very similar to the one shown in FIG. 17. However, the chipset 2302 and the memory bus acceleration system device 2304 are enclosed inside a host device 2300.

FIG. 22 is a block diagram showing a motherboard using a sixth type of memory accelerator according to one preferred embodiment of this invention. The system is very similar to the one shown in FIG. 18. However, the chipset 2402 and the memory bus acceleration system device 2404 are enclosed inside a host device 2400.

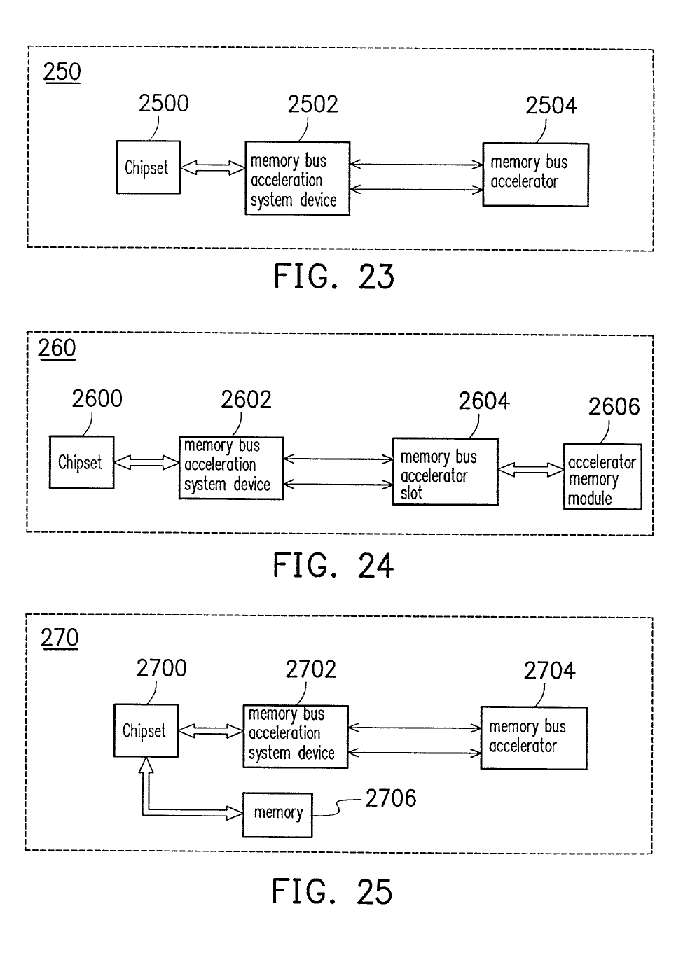

FIG. 23 is a block diagram showing a portable computer motherboard using a first type of memory accelerator according to one preferred embodiment of this invention. The portable computer motherboard 250 at least includes a chipset 2500, a memory bus acceleration system device 2502 and a memory bus accelerator 2504. The memory bus acceleration system device 2502 communicates signals with the chipset 2500. The memory bus accelerator 2504 receives signals from the memory bus acceleration system device 2502 and conducts data transmission or reception accordingly. The memory bus accelerator 2504 also processes signals between the memory bus acceleration system device 2502 and memory.

FIG. 24 is a block diagram showing a portable computer motherboard using a second type of memory accelerator according to one preferred embodiment of this invention. The system is very similar to the one shown in FIG. 23. The memory bus accelerator can be further divided into a memory bus accelerator slot 2604 and an accelerator memory module 2606. The memory bus accelerator slot 2604 receives signals from the memory bus acceleration system device 2602 and conducts data transmission or reception accordingly. The memory bus accelerator slot 2604 also arbitrates the signals between the memory bus acceleration system device 2602 and the accelerator memory module 2606 and accesses data within the accelerator memory module 2606.

FIG. 25 is a block diagram showing a portable computer motherboard using a third type of memory accelerator according to one preferred embodiment of this invention. The system is very similar to the one shown in FIG. 23. However, unlike the system in FIG. 23 with memory attached to the memory bus accelerator, the memory 2706 and the chipset 2700 are coupled together so that memory data can be accessed directly via the chipset 2700.

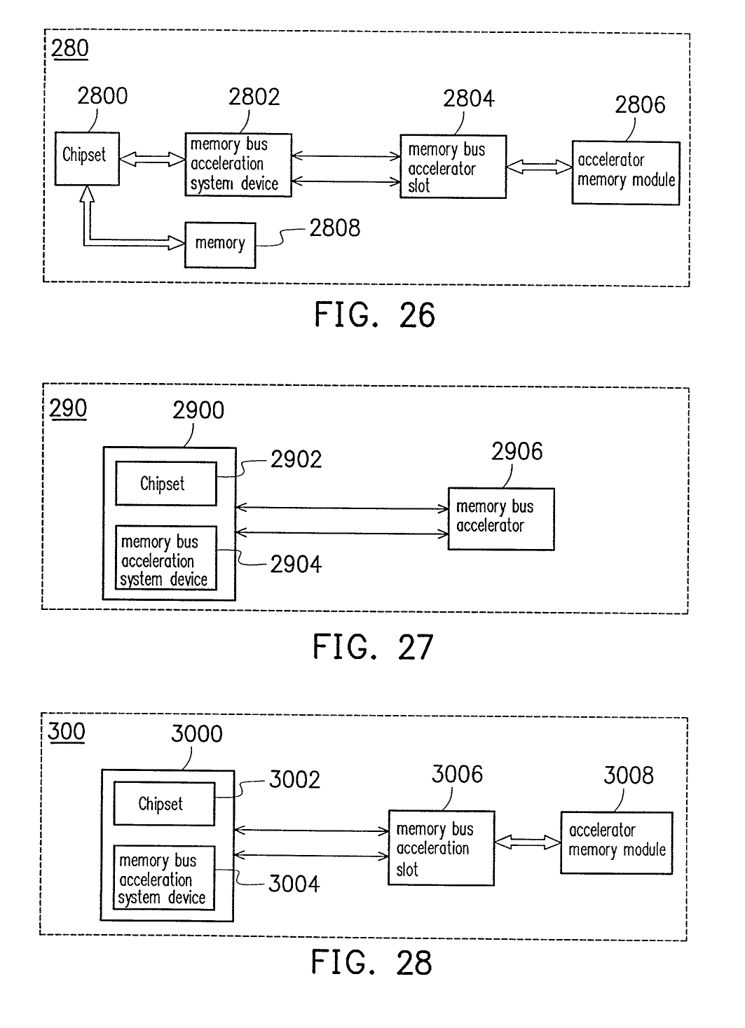

FIG. 26 is a block diagram showing a portable computer motherboard using a fourth type of memory accelerator according to one preferred embodiment of this invention. The system is very similar to the one shown in FIG. 24. However, unlike the system in FIG. 24 with memory attached to the memory bus accelerator slot, the memory 2808 and the chipset 2800 are coupled together so that memory data can be accessed directly via the chipset 2800.

FIG. 27 is a block diagram showing a portable computer motherboard using a fifth type of memory accelerator according to one preferred embodiment of this invention. The system is very similar to the one shown in FIG. 23. However, the chipset 2902 and the memory bus acceleration system device 2904 are enclosed inside a host device 2900.

FIG. 28 is a block diagram showing a portable computer motherboard using a sixth type of memory accelerator according to one preferred embodiment of this invention. The system is very similar to the one shown in FIG. 24. However, the chipset 3002 and the memory bus acceleration system device 3004 are enclosed inside a host device 3000.

FIG. 29 is a block diagram showing an interface card using a first type of memory accelerator according to one preferred embodiment of this invention. The interface card 310 at least includes an interface chipset 3100, a memory bus acceleration system device 3102 and a memory bus accelerator 3104. The memory bus acceleration system device 3102 processes signals between the memory bus accelerator 3104 and the interface chipset 3100. The memory bus accelerator 3104 receives signals from the memory bus acceleration system device 3102 and conducts data transmission or reception accordingly. The memory bus accelerator 3104 also processes signals between the memory bus acceleration system device 3102 and memory.

FIG. 30 is a block diagram showing an interface card using a second type of memory accelerator according to one preferred embodiment of this invention. The system is very similar to the one shown in FIG. 29. The memory bus accelerator can be further divided into a memory bus accelerator slot 3204 and an accelerator memory module 3206. The memory bus accelerator slot 3204 receives signals from the memory bus acceleration system device 3202 and conducts data transmission or reception accordingly. The memory bus accelerator slot 3204 also arbitrates the signals between the memory bus acceleration system device 3202 and the accelerator memory module 3206 and accesses data within the accelerator memory module 3206.

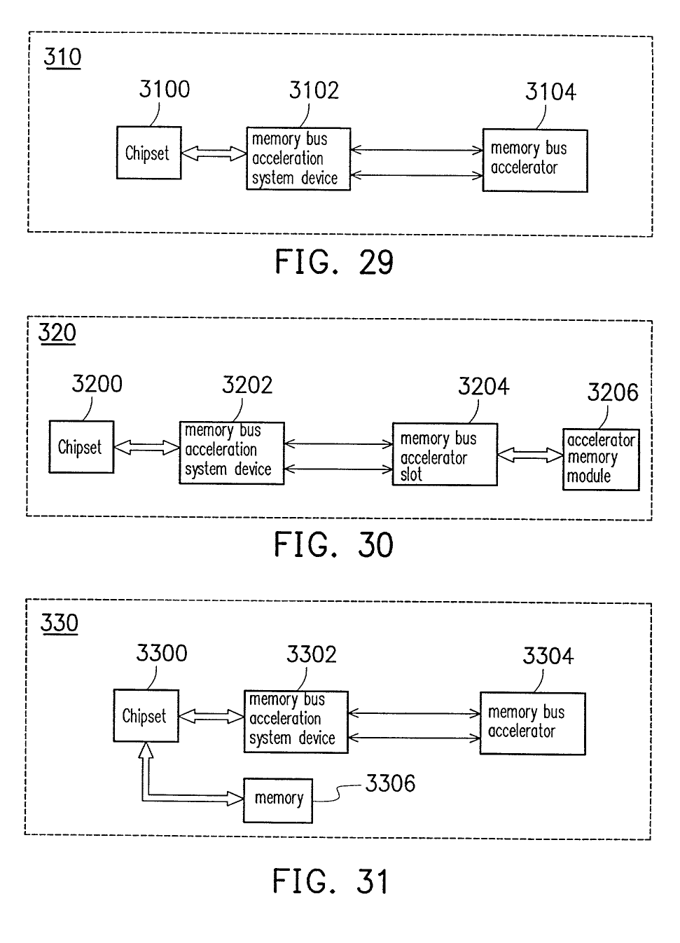

FIG. 31 is a block diagram showing an interface card using a third type of memory accelerator according to one preferred embodiment of this invention. The system is very similar to the one shown in FIG. 29. However, unlike the system in FIG. 29 with memory attached to the memory bus accelerator, the memory 3306 and the interface chipset 3300 are coupled together so that memory data can be accessed directly via the chipset 3300.

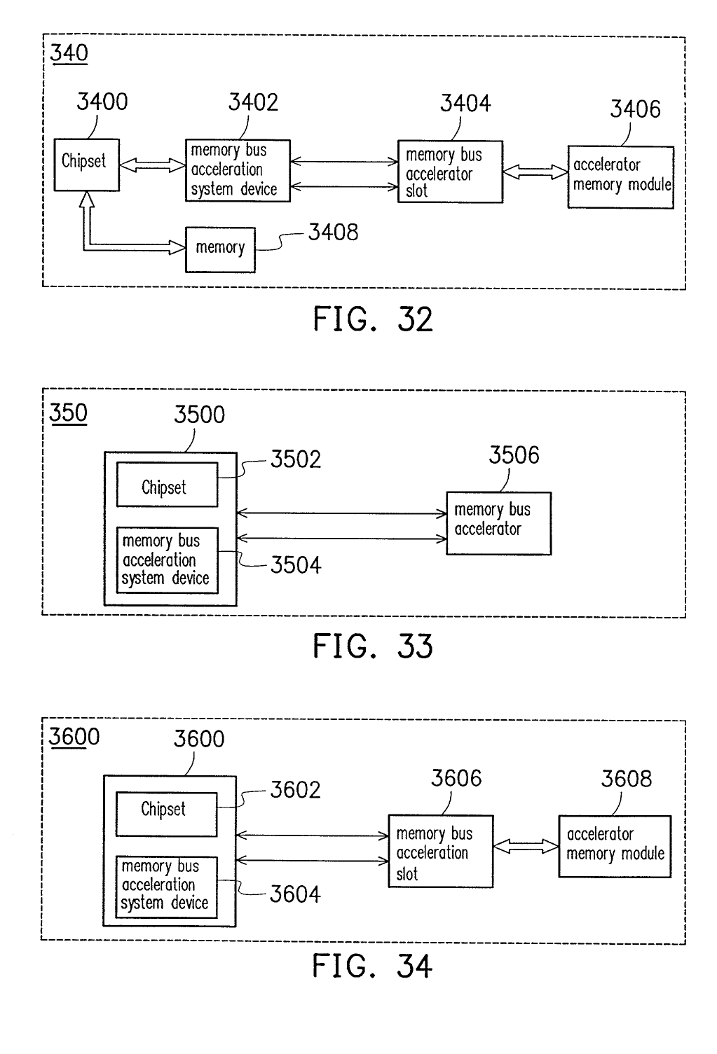

FIG. 32 is a block diagram showing an interface card using a fourth type of memory accelerator according to one preferred embodiment of this invention. The system is very similar to the one shown in FIG. 30. However, unlike the system in FIG. 30 with memory attached to the memory bus accelerator slot, the memory 3408 and the interface chipset 3400 are coupled together so that memory data can be accessed directly via the chipset 3400.

FIG. 33 is a block diagram showing an interface card using a fifth type of memory accelerator according to one preferred embodiment of this invention. The system is very similar to the one shown in FIG. 29. However, the interface chipset 3502 and the memory bus acceleration system device 3504 are enclosed inside a host device 3500.

FIG. 34 is a block diagram showing an interface card using a sixth type of memory accelerator according to one preferred embodiment of this invention. The system is very similar to the one shown in FIG. 30. However, the chipset 3602 and the memory bus acceleration system device 3604 are enclosed inside a host device 3600.

In this invention, memory bus acceleration system devices and memory bus accelerators together control data access between a chipset and a memory. Using a plurality of memory bus accelerators to access data is equivalent to sequentially accessing a series of data from the data bus within an access cycle. Thereafter, a data accessing operation with corresponding memory is conducted. Hence, besides increasing memory capacity, accessing speed of the entire system is also increased. In addition, the application according to this invention can be applied not just to a single circuit or a single type of memory, but also to many types of memory and circuits.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory accelerator, comprising:
a memory bus acceleration system device for processing signals from a chipset;
at least one memory bus accelerator for receiving signals from the memory bus acceleration system device, processing signals between the memory bus acceleration system device and a corresponding memory unit and conducting data accessing operations; and
a memory bus coupled to the memory bus acceleration system device and the memory bus accelerator,
wherein the memory bus acceleration system device receives a data access command from the chipset, converts the data access command into an access command and outputs to the memory bus accelerator so that the memory bus accelerator can sequentially access data on the memory bus and perform a data accessing operation with corresponding memory.

2. The memory accelerator of claim 1, wherein the memory bus acceleration system device further includes:
a data function device for transferring data and controlling data transmission between the chipset and the memory bus accelerator; and
a command state device coupled to the data function device for receiving the data access command from the chipset and state data from the memory bus accelerator and controlling the data function device and the memory bus accelerator accordingly.

3. The memory accelerator of claim 1, wherein the memory bus accelerator further comprises:
a memory interface for transferring data and controlling data transmission between the memory bus acceleration system device and the memory; and
a control memory accelerator coupled to the memory interface for transmitting current state of the memory bus accelerator to the memory bus acceleration system device, receiving a command from the memory bus acceleration system device and controlling the memory interface according to the command.

4. The memory accelerator of claim 3, wherein the memory interface further comprises:
a memory command device for receiving a command from the memory bus accelerator and outputting a memory control signal to the memory according to the command; and
a memory data device for transmitting data and controlling data transmission between the memory bus accelerator and the memory,
wherein the memory data device transfers data and control data transmission after receiving the memory control signal.

5. The memory accelerator of claim 3, wherein the control memory accelerator further comprises:
a data function device for transferring data and controlling data transmission between the memory bus acceleration system device and the memory interface; and
a command state device for transmitting state data of the memory bus accelerator to the memory bus acceleration system device, receiving a command from the memory bus acceleration system device and controlling the memory interface and the data function device accordingly.

6. A motherboard having a memory accelerator, comprising:
a chipset; and
a memory accelerator, comprising:
at least a memory unit;
a memory bus acceleration system device for processing signals from a chipset;
at least one memory bus accelerator for receiving signals from the memory bus acceleration system device, processing signals between the memory bus acceleration system device and a corresponding memory unit and conducting data accessing operations; and
a memory bus coupled to the memory bus acceleration system device and the memory bus accelerator,
wherein the memory bus acceleration system device receives a data access command from the chipset, converts the data access command into an access command and outputs to the memory bus accelerator so that the memory bus accelerator can sequentially access data on the memory bus and perform a data accessing operation with corresponding memory.

7. The motherboard of claim 6, wherein the memory bus accelerator further comprises:
an accelerator memory module for holding data; and
a memory bus acceleration slot coupled to the memory bus acceleration system device for receiving signals from the memory bus acceleration system device and processing the signals and conducting data accessing operations between the memory bus acceleration system device and the memory module.

8. The motherboard of claim 6, wherein the motherboard further includes an external memory coupled to the chipset for holding data.

9. A portable computer motherboard having a memory accelerator therein, comprising:
a chipset; and
a memory accelerator, comprising:
at least a memory unit;
a memory bus acceleration system device for processing signals from a chipset;
at least one memory bus accelerator for receiving signals from the memory bus acceleration system device, processing signals between the memory bus acceleration system device and a corresponding memory unit and conducting data accessing operations; and
a memory bus coupled to the memory bus acceleration system device and the memory bus accelerator,
wherein the memory bus acceleration system device receives a data access command from the chipset, converts the data access command into an access command and outputs to the memory bus accelerator so that the memory bus accelerator can sequentially access data on the memory bus and perform a data accessing operation with corresponding memory.

10. The portable computer motherboard of claim 9, wherein the memory bus accelerator further comprises:
an accelerator memory module for holding data; and
a memory bus acceleration slot coupled to the memory bus acceleration system device for receiving signals from the memory bus acceleration system device and processing signals and conducting data accessing operations between the memory bus acceleration system device and the memory module.

11. The portable computer motherboard of claim 10, wherein the motherboard further includes an external memory coupled to the chipset for holding data.

12. An interface card having a memory accelerator therein, comprising:
an interface chipset; and
a memory accelerator, comprising:
at least a memory unit;
a memory bus acceleration system device for processing signals from an interface chipset;
at least one memory bus accelerator for receiving signals from the memory bus acceleration system device, processing signals between the memory bus acceleration system device and a corresponding memory unit and conducting data accessing operations; and
a memory bus coupled to the memory bus acceleration system device and the memory bus accelerator, wherein the memory bus acceleration system device receives a data access command from the interface chipset, converts the data access command into an access command and outputs to the memory bus accelerator so that the memory bus accelerator can sequentially access data on the memory bus and perform a data accessing operation with corresponding memory.

13. The interface card of claim 12, wherein the memory bus accelerator further comprises:
an accelerator memory module for holding data; and
a memory bus acceleration slot coupled to the memory bus acceleration system device for receiving signals from the memory bus acceleration system device and processing the signals and conducting a data accessing operation between the memory bus acceleration system device and the memory module.

14. The interface card of claim 12, wherein the motherboard further includes an external memory coupled to the interface chipset for holding data.

15. A method for increasing memory accessing speed, wherein the method utilizes a plurality of memory bus accelerators to transfer a plurality of data batches to and from a memory unit, the method comprising the steps of:
providing an access cycle;
providing an access command; and
commanding the memory bus accelerators to access data sequentially within an access cycle according to the access command and performing memory access with corresponding memory.
